(19) United States
(12) Patent Application Publication
(10) Pub. No.: US 2008/0154673 A1
(43) Pub. Date: Jun. 26, 2008

(54) LOAD-BALANCING STORE TRAFFIC

(75) Inventors: Michael Connolly, Seattle, WA (US); Lili Cheng, Bellevue, WA (US); David M. Chickering, Bellevue, WA (US); Gary W. Flake, Bellevue, WA (US); Alexander G. Gounares, Kirkland, WA (US); Eric J. Horvitz, Kirkland, WA (US); Kamal Jain, Bellevue, WA (US); Christopher A. Meek, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/862,820

(22) Filed: Sep. 27, 2007

Related U.S. Application Data
(60) Provisional application No. 60/870,926, filed on Dec. 20, 2006.

(51) Int. Cl. G06Q 30/00; G06F 17/40

(52) U.S. Cl. 705/7

(57) ABSTRACT

The claimed subject matter relates to an architecture that can identify relevant features or characteristics of one or more shoppers in the vicinity of a business establishment. In addition, the architecture can monitor resources both of the business establishment as well as other remote or disparate businesses. Based upon the shopper traffic data and the resource data, the architecture can determine or infer a traffic modifier (e.g., an advertisement or incentive) that can be transmitted to a display device that is typically in close proximity to the business establishment in order to modify behavior of the shopper as well as to adjust resources based upon inferred results of the modified behavior.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” This application is related to U.S. application Ser. No. 11/767,360, filed on Jun. 22, 2007, entitled “MOBILE AD SELECTION AND FILTERING,” and also related to U.S. Application Serial number (MSFTP1732US) ______, filed on ______, entitled “SHOPPING ROUTE OPTIMIZATION AND PERSONALIZATION.” The entireties of these applications are incorporated herein by reference.

### BACKGROUND

Advertisers are continually looking for new ways to reach potential customers with advertisements. Advertisements can increase public awareness as well as name recognition or other forms of goodwill for a business establishment, and can often be accompanied by an incentive such as discounts for certain merchandise, a discount for a particular product or service, or a discount for some other resource supplied by the business establishment. Advertisements can be blanket ads that are directed to the populace at large or tailored in some way to appeal to a particular consumer. Traditionally, there are a number of difficulties associated with conventional advertising that can exist irrespective of whether or not an advertisement is a blanket ad or targeted in some way to a specific consumer.

One such difficulty is that advertisements have diminishing returns or effects as time passes between observation of the advertisement and access to the resource being advertised. Hence, an ad directed to a new pair of shoes might steadily lose its value as time passes between consumption of the ad and patronage of the shopping mall where the advertising shoe store is located. One conventional means of countering this difficulty is to provide location-based advertisements such as billboard advertisement in the vicinity of the business establishment. However, such location-based ads are by default blanket ads and cannot be reliably targeted by conventional means since the advertiser has almost no ability to control or predict which shoppers will observe the ad.

Another difficulty exists in that a business establishment has very little ability to predict temporal effects of an advertisement. For example, while an advertisement that runs in a newspaper may predictably increase sales or another type of resource utilization over a period of, say, a week, it is rarely possible to make less granular predictions such as what the effects of the ad will be over the next hour. Given numerous cost-savings techniques such as just-in-time (JIT) inventories and the like, such unknown variables can lead to inefficiencies as well as a loss of goodwill.

Still another difficulty associated with some forms of advertising such as targeting advertising is that most ad target models rely on private information in order to build a consumer profile. Hence, these models often rely upon the consumer opting-in to receive some benefit in exchange for the private information. Thus, these models have little or no ability to select the shoppers that will be targeted at any given location.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can employ environment and/or resource data to facilitate more efficient management of shopper traffic or business resources. To the accomplishment of the foregoing and other related ends, the architecture can monitor shopper traffic (as well as other environmental variable) in order to determine relevant characteristics or features of the shopper traffic, either in the aggregate or with respect to a single shopper or a subset of shoppers. It should be appreciated that whereas conventional advertisement systems or models tend to rely upon private information, the claimed subject matter can employ (exclusively in some cases) public information such as what is visible or discernible about shoppers in public settings.

In addition, the architecture can monitor resources related to a business establishment including but not limited to inventory of the business establishment, equipment possessed by the business establishment, personnel (on- or off-duty) for the business establishment, a schedule for the business establishment such as a schedule for utilization of a product, service, and/or other resource, or a budget for the business establishment such as an advertising expense budget.

In accordance with the foregoing, the architecture can construct traffic data relating to the shopper traffic and resource data relating to the resources of the business establishment. The traffic data and the resource data can be comprised of identified features as well as suitable determinations or inferences, and can be collectively employed to construct a traffic modifier. Moreover, the traffic modifier can be constructed in real time to, for example, be more useful or relevant for the current shopper traffic.

In an aspect of the claimed subject matter, the traffic modifier can be determined or inferred to drive shopper traffic to an abundant resource. In another aspect, the traffic modifier can be determined or inferred to divert shopper traffic from a scarce resource. In yet another aspect, the traffic modifier can be determined or inferred to delay or expedite consumption of a particular resource. For example, the traffic modifier can be an advertisement that drives local traffic (e.g., based upon extant characteristics of shopper traffic identified or inferred) to an abundant resource. In contrast, the traffic modifier can be an advertisement that diverts traffic to another store (e.g., based upon resource data) where a desired resource is more abundant and/or to prevent long lines or inventory/schedule inefficiencies. As another example, the traffic modifier can be an advertisement for a particular resource that is only redeemable prior to a given time (e.g., expedite resource utilization) or only redeemable after a given time (e.g., delay resource utilization).

According to an aspect of the claimed subject matter, the architecture can further determine or infer a resource modifier. The resource modifier can be based upon an inference related to an expected result of dissemination of the traffic modifier. For example, the effects of the traffic modifier upon shopper traffic can be projected and applied to the current state of resources for the business establishment. Based upon these results, certain resources can be updated or augmented.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 depicts a block diagram of a computer implemented system that can employ environment and/or resource information to facilitate more efficient management of shopper traffic and/or resource allocation.

FIG. 2 is a block diagram of a system that illustrates various features or aspects of the environment monitoring component.

FIG. 3 illustrates a block diagram a system that depicts various features or aspects of resource monitoring component.

FIG. 4 depicts a block diagram of a system that illustrates various features or aspects of management component.

FIG. 5 is a block diagram of a computer implemented system that that can aid with various inferences.

FIG. 6 is an exemplary flow chart of procedures that define a method for facilitating more efficient managing of shopper traffic and/or resource allocation based at least in part upon environment and/or resource data.

FIG. 7 is an exemplary flow chart of procedures that define a method for receiving additional data and/or for inferring aspects or characteristics associated with shopper traffic.

FIG. 8 depicts an exemplary flow chart of procedures defining a method for utilization of traffic and/or resource modifiers.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. For example, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

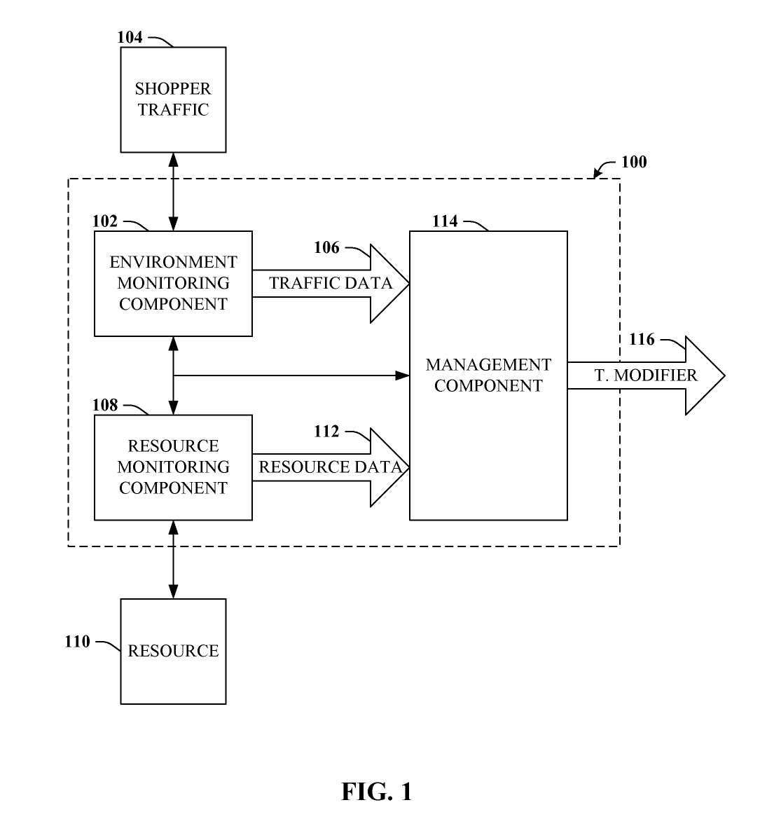

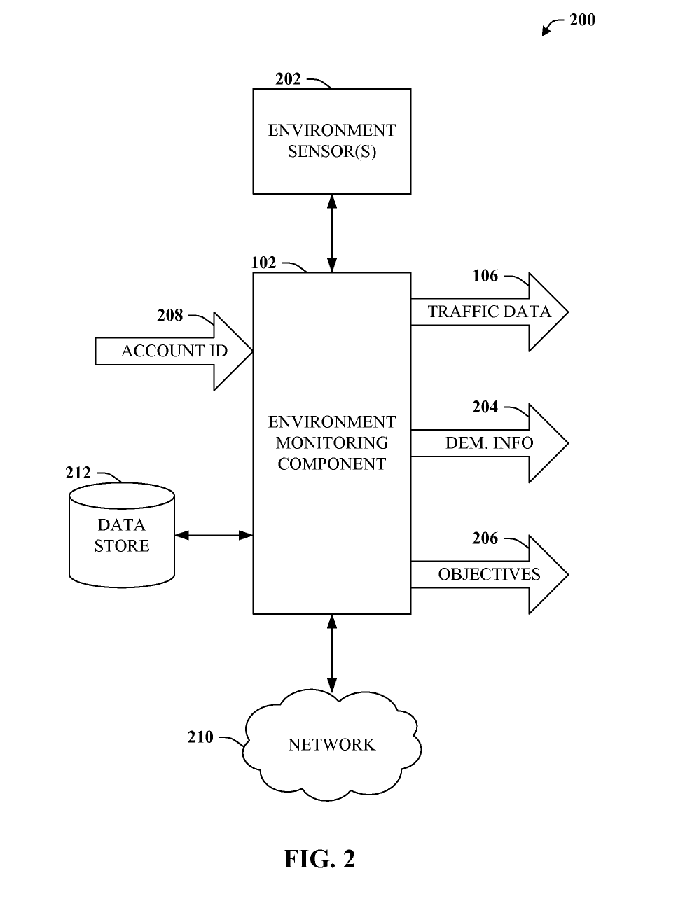

Referring now to the drawing, with reference initially to FIG. 1, computer implemented system 100 that can employ environment and/or resource information to facilitate more efficient management of shopper traffic and/or resource allocation is depicted. Generally, system 100 can include environment monitoring component 102 that can monitor shopper traffic 104. Environment monitoring component 102 can further transmit traffic data 106 that is associated with shopper traffic 104. In particular, traffic data 106 can include various relevant aspects identified and/or determined from shopper traffic 104 by environment monitoring component 102, which will be further detailed in connection with FIG. 2 infra. Shopper traffic 104 can include any number of individual shoppers that are subject to analysis by environment monitoring component 102.

The term “shopper,” as used herein, is intended to mean a potential customer and is not necessarily limited only to entities or individuals who have made or plan to make a purchase. Hence, a shopper can be an entity or individual who patronizes a business establishment or nearby locations; is on the premises of the business establishment or in relatively close proximity to the premises; or one who receives an advertisement from the business establishment, irrespective of whether or not the shopper makes a purchase and irrespective of whether or not the shopper intends to make a purchase. A shopper who does or has previously made a purchase or some other suitable transaction with the business establishment can be distinguished by and denoted as a “customer.” Thus, while such a distinction is not necessarily essential to understanding the claimed subject matter, it is to be appreciated that shopper traffic 104 can relate to both shoppers and customers.

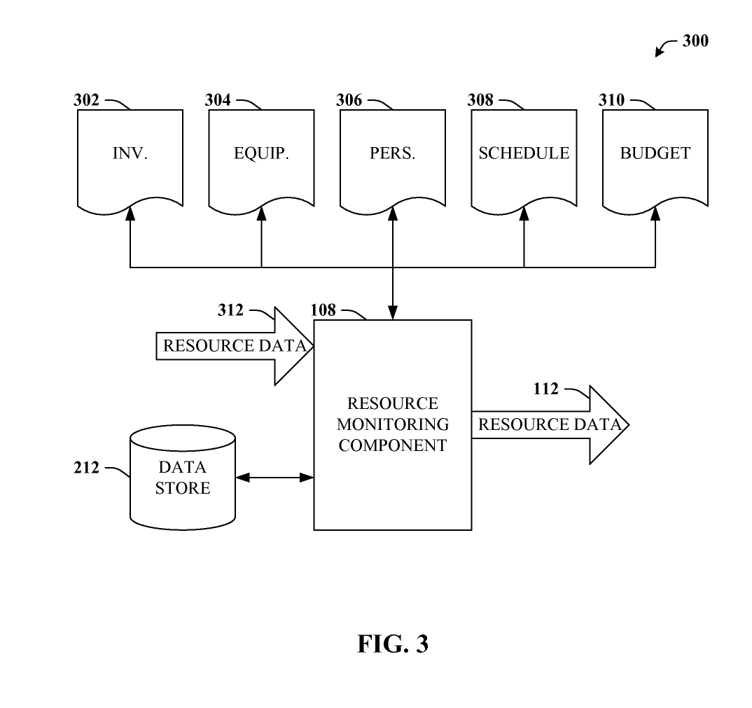

System 100 can also include resource monitoring component 108 that can monitor resource 110, and that can transmit resource data 112 that is associated with resource 110. Typically, resource 110 will be related to a business establishment, often a local business establishment. However, it is to be appreciated that resource 110 can in addition or in the alternative relate to a remote business establishment. Resource 110 can be, for example, inventory for the business establishment, equipment for the business establishment, personnel (on- or off-duty) for the business establishment, a schedule for the business establishment such as a schedule for utilization of a product, service, and/or resource 110, or a budget for the business establishment such as an advertising expense budget. Resource monitoring component 108 is described in further detail in connection with FIG. 3.

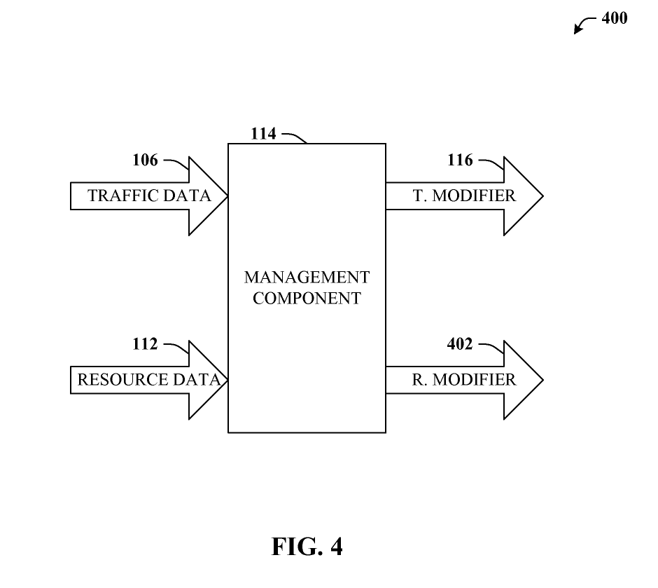

In addition, system 100 can include management component 114. Management component 114 can employ traffic data 106 and/or resource data 112 in order to determine or infer traffic modifier 116. Traffic modifier 116 can be an action, event, or policy for which implementation or realization of that action, event, or policy will likely affect shopper traffic 104 in a desired manner. For example, traffic modifier 116 can be determined or inferred to affect shopper traffic 104 such that shopper traffic 104 is driven toward an abundant resource (e.g., resource 110). As another example, traffic modifier 116 can affect shopper traffic 104 such that shopper traffic 104 is diverted away or temporarily delayed from consuming a scarce resource (e.g., resource 110). It is to be appreciated that traffic modifier 116 can be determined in real time. Hence, a certain feature of an individual shopper included in shopper traffic 104 can be captured by traffic data 106 and utilized by management component 114 to generate traffic modifier 116, and, therefore, the shopper can be exposed to the implementation of traffic modifier 116. Further explanation and examples associated with management component 114 can be found in connection with FIG. 4.

Turning now to FIG. 2, system 200 is depicted, which illustrates various features or aspects of environment monitoring component 102. As described, supra, environment monitoring component 102 can monitor shopper traffic 104 and transmit certain relevant features associated with shopper traffic 104 as traffic data 106. In one aspect, environment monitoring component 102 can monitor physical traffic in or surrounding a business establishment. In accordance therewith, environment monitoring component 102 can include or be operatively coupled to one or more environment sensor(s) 202. Environment sensor 202 can be substantially any device that can detect or identify relevant features or characteristics relating to shopper traffic 104 or a local environment, such as, for example, a camera (e.g., still, video, infrared . . . ), a motion detector, or the like. Hence, the features or characteristics of shopper traffic 104 identified, employed, or found relevant to the claimed subject matter can, but need not necessarily, be entirely comprised of public information.

According to an aspect of the claimed subject matter, environment monitoring component 102 can receive information from environment sensor 202 that can be utilized to infer demographic information 204 or objectives information 206 from shopper traffic 104. For example, a video camera (e.g., environment sensor 202) can record shoppers in or nearby the business establishment, and the environment monitoring component 102 can identify a wide range of demographic information 204 as well as other types of information from the video input, including but not limited to age, gender, body type, dress type, apparel quality or condition, and so on. Similarly, environment monitoring component 102 can infer objectives information based upon certain behaviors.

It is to be appreciated that demographic information 204 and/or objectives information 206 can be determined or inferred with respect to a single shopper as well as in the aggregate or with respect to a collection of shoppers. For instance, environment monitoring component 102 can detect that shopper traffic 104 includes a shopper with lots of jewelry, which can be relevant traffic data 106 (e.g., suggestive of an interest in jewelry purchasing and/or finding matching jewelry) or demographic information 202 (e.g., suggestive of purchasing conventions or a budget given the quality or nature of the jewelry). As an aggregation example, environment monitoring component 102 can determine that, say, an unusually high number of middle-aged men have been entering or passing by the business establishment in the last 90 minutes, or, similarly, a disproportionate number of shoppers have been identified to be wearing running shoes. Such information can be useful in a variety of ways as is described in more detain infra.

In addition, data obtained from environment sensor(s) 202 can be used to infer objectives information 206 about shopper traffic 104. For example, a shopper who spends several minutes in the children's department might be inferred to have an objective of making a purchase for a child. Likewise, a female shopper in the men's department or a male shopper in the lingerie department can likewise be associated with gift-giving objectives. As another example, a shopper's behavior or biometrics can be employed to infer objectives. For example, certain gestures or body language (e.g., throwing one's hands in the air) might indicate frustration and/or an objective to find a knowledgeable employee and/or be indicative of an area or policy that is confusing to shoppers. Similar information can be obtained from infrared or biometric sensors 202.

In some cases environment monitoring component 102 can also receive a customer account ID 208 associated with a known customer. For example, information can be exchanged between the business establishment and a mobile device. Thus, when the customer is in geographic proximity to the business establishment, such information can be readily attained. It should be understood that by identifying a shopper as a known customer or someone with whom there are previous transactions, that shopper can be associated with an existing profile, potentially facilitating additional targeting, personalization, and/or management. Moreover, by receiving the account ID 208 by way of a mobile device, a host now has a known and useful communication channel by which to deliver suitable information. While mobile devices and/or account ID 208 can be convenient and powerful ways to identify a customer, other ways exist as well. For example, environment monitoring component 102 can employ facial recognition techniques. Furthermore, in a related aspect environment monitoring component 102 can employ other types of recognition techniques to identify characteristics of the shopper's apparel such as size, brand, style, age, condition, quality, and so forth.

Account ID 208 can be received by way of network 210, which can include one or more types of computer networks such as the Internet or another wide area network (WAN), intranets, extranets, local area network (LAN), wireless, cellular, etc. Hence, environment monitoring component 102 can receive account ID 208 from a mobile device when the shopper is in geographic proximity of the business establishment. Furthermore, environment monitoring component 102 can monitor shopper traffic 104 that is online as well. For example, environment monitoring component 102 can receive, determine, or infer various characteristic (e.g., data 106, information 204, 206, ID 208) associated with an online shopper, which can be received by way of network 210.

It is to be appreciated and understood that environment monitoring component 102 can receive raw data from environment sensor(s) 202 in order to determine or infer relevant aspects (e.g., traffic data 106, demographic information 204, objectives information 206), which can be transmitted to management component 114 for further application. Furthermore, all data or information received or inferred can be stored in data store 212 for later access or recall.

With reference now to FIG. 3, system 300 is provided, which depicts various features or aspects of resource monitoring component 108. Generally, resource monitoring component 108 can monitor resources 110 associated with a business establishment, and can transmit relevant resource data 112 (e.g. to management component 114) as indicated supra. In more detail, resource data 112 can include inventory 302 of the business establishment, such as items in stock, on display, or on shelves. Resource data 112 can also include equipment 304 of the business establishment such as vehicles, devices or other equipment 304 necessary or useful in creating revenue or otherwise furthering business goals. Personnel 306 such as employees or types of employees (e.g., sales staff, management, relations, etc.) of the business establishment can be included in resource data 112. Furthermore, resource data 112 can include schedule 308, which can relate to temporal aspects or availability of other resources 110, as well as include budget 310, which can relate to various economic allocations such as, for example, an advertising budget. By monitoring resources 110, resource monitoring component 108 can, for example, identify conditions of abundance or scarcity for various resources 110 of the business establishment.

In addition, resource monitoring component 108 can also receive resource data 312 that can be substantially similar to resource data 112, yet associated instead with a disparate business establishment. Accordingly, a condition of abundance or scarcity for a disparate business resource can also be identified, and included in the information transmitted as resource data 112. Furthermore, resource monitoring component 108 can also be coupled to network 210 and data store 212. Thus, resource data 312 can be received e.g., by way of network 210 and any suitable data (e.g., resource data 112, 312) can be stored to data store 212 for later access or reference.

Referring now to FIG. 4, system 400 is depicted, which illustrates various features or aspects of management component 114. Recall, management component 114 can employ traffic data 106 and resource data 112 to determine traffic modifier 116. By utilizing both traffic data 106 and resource data 112, a potentially unforeseen benefit arises in that shopper traffic 104 can be affected and/or manipulated efficiently based upon available resources 110 and in real time. For example, traffic modifier 116 can be determined or inferred to drive shopper traffic 104 to resources 110 that are abundant. Similarly, traffic modifier 116 can be determined or inferred to divert or delay shopper traffic 104 with respect to resources 110 that are scarce. Hence, shopper traffic 104 can be efficiently managed in real time based upon real time information.

In order to provide additional context for the foregoing, but not necessarily intended to limit the scope, a number of illustrative examples are now provided. As one example, traffic modifier 116 can be a conditional incentive that is only redeemable at a disparate business establishment. For instance, management component 114 can receive traffic data 106 that indicates a particular resource 110 is or likely will be highly utilized. In addition, resource data 112 might further indicate that the resource 110 is already scarce. Such a condition can lead to inefficiencies and/or customer dissatisfaction, however, resource data 112 might specify that a disparate business establishment (e.g., another branch, affiliate, sister store, or even a competitor under some circumstances) has an abundance of the resource 110. Accordingly, the above situation can potentially be mitigated by a conditional incentive (e.g., traffic modifier 116) that indicates, e.g., a 15% cost savings is available at the disparate business establishment. Hence, shopper traffic 104 can be diverted to another location by the incentives provided by traffic modifier 116.

As another example, traffic modifier 116 can be a conditional incentive that is only redeemable after a period of time, wherein the period can be inferred based upon when a potential burden on a resource will be relieved. For example, management component 114 can determine that while resource 110 is currently or will be heavily utilized, this condition will be relieved in about 90 minutes. Accordingly, traffic modifier 116 can be, e.g., an incentive that indicates a discount can be obtained but only after at least an hour and a half from the current time.

As yet another example, traffic modifier 116 can be a conditional incentive that is only redeemable prior to a period of time, wherein the period is inferred based upon when a potential burden on a resource will appear. For example, management component 114 can determine that a burden (e.g., scarce condition) will begin to appear with respect to resource 110 in 30 minutes. Accordingly, traffic modifier 116 can be, e.g., an incentive that indicates a discount can be obtained but only if redeemed within the next half hour. It is to be appreciated that combinations of the foregoing can exist as well. For instance, traffic modifier 116 can include an indication of an incentive that is redeemable within a given time range such as only after 90 minutes from now, but before 3 hours from now, based upon the scarcity and/or abundance of resource 110 for that time period.

According to an aspect of the claimed subject matter, traffic modifier 116 can be an advertisement that is selected based upon a characteristic identified or inferred that is highly represented in shopper traffic 104. For example, consider the case in which environment monitoring component 102 determines that a high percentage of shopper traffic 104 comprised of middle-aged men, shoppers wearing running shoes, or some other characteristic or behavior. Given this determination, an appropriate advertisement can be selected to appeal to a particular demographic and/or highly represented characteristic or behavior.

In one aspect of the claimed subject matter, traffic modifier 116 can be an advertisement that is selected based upon a characteristic identified or inferred, wherein the characteristic is associated with an individual shopper. For example, environment monitoring component 102 can identify a shopper who spends several minutes in a particular department, one who wears certain apparel or jewelry, one who exhibits signs of frustration (e.g., trying to get assistance about a product or service) or impatience (e.g., waiting while another shopper tries on various outfits). Based upon such a determination, an appropriate advertisement or notification can be created.

In either case, whether constructing traffic modifier 116 based upon a highly represented characteristic in shopper traffic 104 or based upon a characteristic of an individual shopper, another difficulty can exist in propagating traffic modifier 116 in a manner such that suitable members of shopper traffic 104 can be apprised of the advertisement or incentive in a way that is effective and/or of a real time nature. In the event environment monitoring component 102 has received account ID 208 for one or several of the suitable shoppers, then traffic modifier 116 has a natural platform to be received (e.g., by way of the mobile device from which account ID 208 was received). Accordingly, one or several of the middle-aged men identified in shopper traffic 104 can conveniently receive the advertisement or incentive by way of a mobile device. Likewise, a shopper exhibiting impatience while waiting for a companion to try on numerous outfits can have a catalog or entertainment-based advertisement delivered to his or her mobile device, e.g., to help idle away the requisite wait time.

In another aspect of the claimed subject matter, the advertisement can be transmitted to a display device such as an electronic billboard, kiosk, and so forth. Thus, a highly represented characteristic extant in shopper traffic 104 can be targeting even without certain knowledge of the individual shoppers (e.g., a “Physic Billboard”). For example, an electronic billboard near the entrance to the business establishment can display an advertisement that is directed to middle-aged men in order to capture or appeal to that demographic identified to be highly represented in shopper traffic 104. Similarly, a kiosk, monitor, or other display device near the changing rooms can display an entertaining short or commercial aimed at relieving a particular shopper's impatience, or even display something that is strikingly tailored to the shopper based upon discernible features.

As yet another potentially unforeseen benefit of the claimed subject matter, while most business establishments conventionally employ only a small number of concurrent advertisements or promotions, by employing the claimed subject matter, advertisements (or other traffic modifiers 116) can be tailor-made resulting in a much larger set of concurrent promotions that can address a much larger set of potentialities and/or opportunities.

In accordance with another aspect, management component 114 can also determine resource modifier 402. Resource modifier 402 can be based upon a determination or inference related to an expected result of dissemination of traffic modifier 116. For example, a mass advertisement (e.g., traffic modifier 116) directed toward the middle-aged men demographic and propagated to a billboard can result in a sharp change in shopper traffic 104 as many of the target demographic alter their respective courses in response to the advertisement. Thus, management component 114 might also infer that sales staff (e.g., personnel 306) or another resource 110 should be temporarily adjusted to account for the ensuing and/or predicted increased utilization of that resource 110.

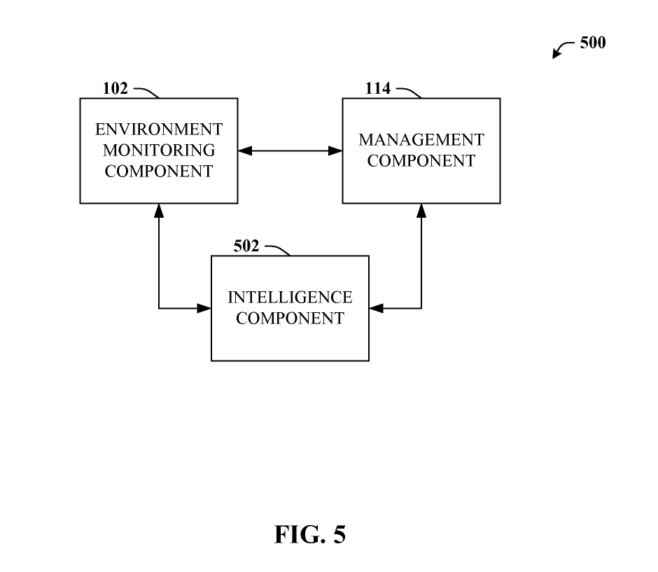

Turning now to FIG. 5, system 500 that can aid with various inferences is depicted. Generally, system 500 can include environment monitoring component 102 that can monitor shopper traffic 104 in order to determine or infer traffic data 106. In addition, system 500 can include management component 114 that can employ traffic data 106 and resource data 112 in order to infer traffic modifier 116. While not expressly illustrated, it is to be appreciated that system 500 can also include resource monitoring component 108.

In addition, system 500 can also include intelligence component 502 that can provide for or aid in various inferences or determinations. It is to be appreciated that intelligence component 502 can be operatively coupled to all or some of the aforementioned components. Additionally or alternatively, all or portions of intelligence component 502 can be included in one or more of the components 102, 108, 114. Moreover, intelligence component 502 will typically have access to all or portions of data sets described herein, such as data store 212 or those available by way of network 210, and can furthermore utilized previously determined or inferred data such as traffic data 106, resource data 112, traffic modifier 116, resource modifier 402, and so on.

Accordingly, in order to provide for or aid in the numerous inferences described herein, intelligence component 502 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

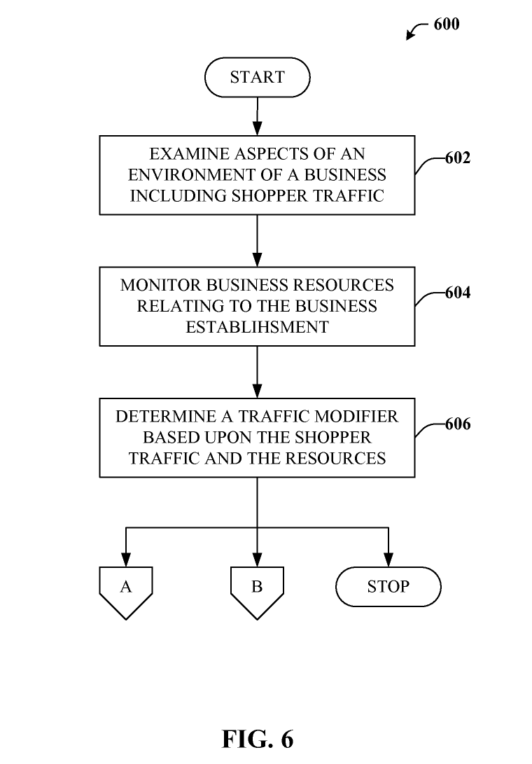

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 6, exemplary computer implemented method 600 for facilitating more efficient managing of shopper traffic and/or resource allocation based at least in part upon environment and/or resource data is illustrated. In general, at reference numeral 602, aspects of an environment geographically local to a business establishment can be examined. More particularly, the aspects examined can at least include shopper traffic, wherein shopper traffic can relate to a collection of shoppers. It is to be understood that a shopper can be an individual who patronizes a business establishment or nearby locations, is on the premises of the business establishment or in relatively close proximity to the premises, or one who receives an advertisement from the business establishment, irrespective of whether or not the shopper makes a purchase and irrespective of whether or not the shopper intends to make a purchase.

At reference numeral 604, business resources relating to the business establishment can be monitored. Business resources can include, e.g., inventory of the business establishment, equipment of the business establishment, personnel employed by the business establishment, a schedule relating to one or more resources of the business establishment, a budget for the business establishment, and so on and so forth. As one notable example, various conditions with respect to business resources can be monitored such as a condition of scarcity, a condition of abundance, a utilization burden or relief on the resource, and/or an availability of the business resource.

At reference numeral 606, a traffic modifier can be determined based at least in part upon the shopper traffic and the business resources. It is to be appreciated that the traffic modifier can be determined in real time. Hence, a certain feature highly represented in the shopper traffic or a feature of an individual shopper included in the shopper traffic can be identified and included in the traffic data and utilized to determine the traffic modifier such that extant shopper traffic can be effectively targeted and/or efficiently modified by the traffic modifier.

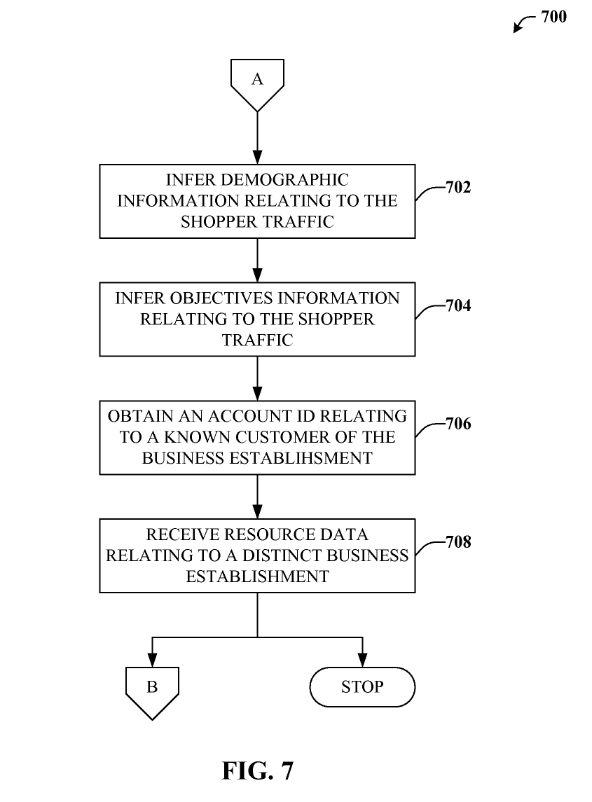

With reference now to FIG. 7, an exemplary computer implemented method 700 for receiving additional data and/or for inferring aspects or characteristics associated with shopper traffic is portrayed. Generally, at reference numeral 702, demographic information relating to shopper traffic can be inferred. For example, by monitoring aspects of an environment local to a business establishment as described in connection with act 602 of FIG. 6 certain demographic information such as age, gender, interests, disposable income, etc. can be determined or inferred.

Likewise, in a similar fashion, at reference numeral 704 various objectives information such as interests, shopping goals, free time, needs, and the like can be determined or inferred based upon the monitoring of shopping traffic detailed supra at act 602. Based upon these and other inferences described herein, the traffic modifier can be determined or inferred as described in connection with act 606.

Moreover, further to what has been described, additional information can be obtained to, e.g., provide ready communications paths to shoppers, identify remote resources that are available, or the like. For example, at reference numeral 706, a customer account ID relating to a known customer of the business establishment who is in the physical vicinity of the business establishment can be obtained. As one example, an indication of the foregoing can be obtained from a mobile device that is in proximity to a receiver or sensor of the business establishment. At reference numeral 708, resource data relating to a distinct business establishment can be received. For instance, data relating to abundant or scarce resources of a branch or affiliate of the business establishment can be received. Based upon such information, the traffic modifier can be constructed in a more efficient manner.

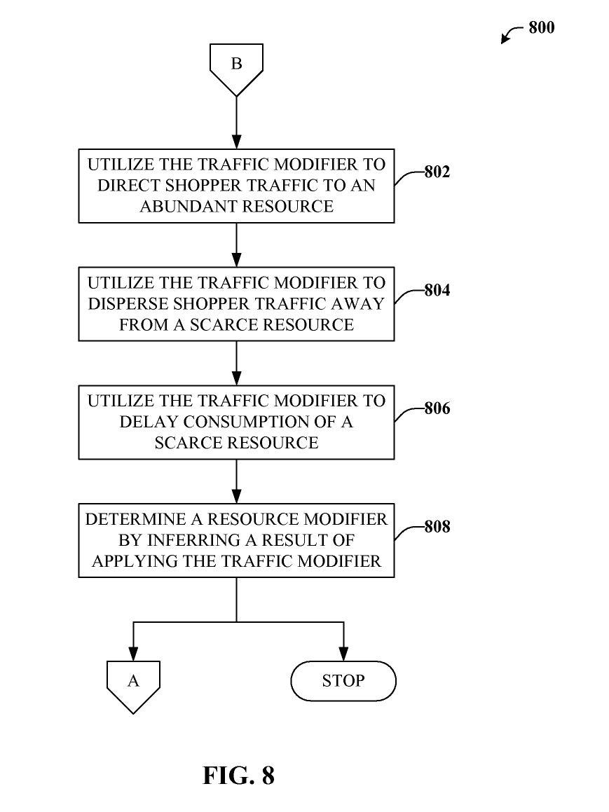

Turning now to FIG. 8, an exemplary method 800 for utilization of traffic and/or resource modifiers is illustrated. In general, at reference numeral 802, the traffic modifier can be utilized to direct shopper traffic to an abundant resource. For example, if the shopper traffic is heavily represented by middle-aged men, and further, the business establishment has or can be modified to have an abundant resource suitable for the middle-aged men demographic, then the traffic modifier can be utilized to direct that demographic to the abundant resource of the business establishment.

Likewise, at reference numeral 804, the traffic modifier can be utilized to disperse shopper traffic away from a scarce resource, while, at reference numeral 806, the traffic modifier can be utilized to delay consumption of a scarce resource. For example, based upon an inference (e.g., based upon shopper traffic) that one or more resources will be subject to heavy utilization and/or a condition of scarcity, the traffic modifier can be directed to, say, middle-aged men in the business establishment and aimed it diverting that demographic to a different locale (e.g. a disparate business establishment) where the desired resource is more abundant and/or delaying consumption of the desired resource to a later time, such as when additional resources will become available.

At reference numeral 708, a resource modifier can be determined by inferring a result of applying the traffic modifier. For example, based upon the previous example, of a traffic modifier aimed at the highly represented segment of shopper traffic defined as middle-aged men, such a traffic modifier can result in an over-utilization of certain resources. Accordingly, such resources can be prepared in advance to support the projected utilization by employing the resource modifier. Hence, the resource modifier can, e.g., suggest or authorize a change in personnel, a change in stock or displays, as well as changes in aspects of other resources.

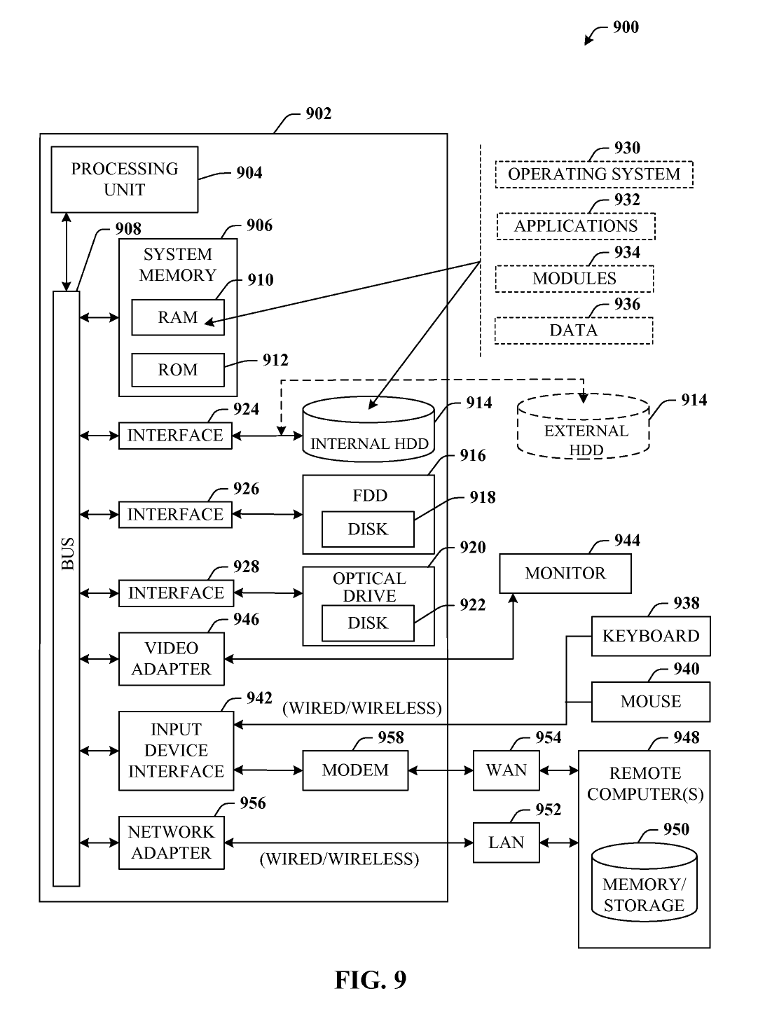

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic “10 BaseT” wired Ethernet networks used in many offices.

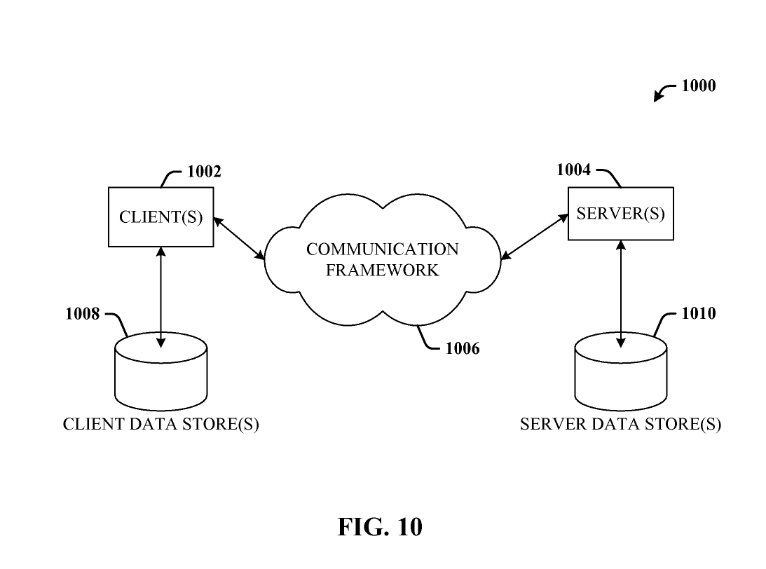

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that employs environment and/or resource data to facilitate more efficient management of shopper traffic and/or resource allocation, comprising:
an environment monitoring component that monitors shopper traffic, and that transmits associated traffic data;
a resource monitoring component that monitors a resource related to a business establishment, and that transmits resource data associated with the resource; and
a management component that employs the traffic data and the resource data to determine a traffic modifier.

2. The system of claim 1, the environment monitoring component monitors physical traffic in or immediately surrounding the business establishment.

3. The system of claim 1, the environment monitoring component infers demographic information or objectives information from the shopper traffic.

4. The system of claim 1, the environment monitoring component monitors online shopper traffic that is facilitated by a computer network.

5. The system of claim 1, the environment monitoring component receives a shopper account ID associated with a known customer in geographic proximity.

6. The system of claim 1, the resource is at least one of inventory, equipment, personnel, a schedule, or a budget.

7. The system of claim 1, the resource monitoring component receives resource data associated with a disparate business establishment.

8. The system of claim 1, the traffic modifier is determined to drive the shopper traffic to abundant resources.

9. The system of claim 1, the traffic modifier is determined to divert or delay shopper traffic with respect to scarce resources.

10. The system of claim 1, the traffic modifier is conditional incentive that is only redeemable at a disparate business establishment.

11. The system of claim 1, the traffic modifier is a conditional incentive that is only redeemable after a period of time, the period is inferred based upon when a potential burden on the resource will be relieved.

12. The system of claim 1, the traffic modifier is a conditional incentive that is only redeemable prior to a period of time, the period is inferred based upon when a potential burden on the resource will be appear.

13. The system of claim 1, the traffic modifier is an advertisement that is selected based upon a characteristic identified or inferred that is highly represented in the shopper traffic.

14. The system of claim 1, the traffic modifier is an advertisement that is selected based upon a characteristic identified or inferred, the characteristic is associated with a shopper.

15. The system of claim 1, the traffic modifier is an advertisement that is transmitted to a display device proximal to the business establishment.

16. The system of claim 1, the management component determines a resource modifier based upon an inference related to an expected result of dissemination of the traffic modifier.

17. A computer-implemented method for facilitating efficient managing of shopper traffic and/or resource allocation based at least in part upon environment and/or resource data, comprising:
examining aspects of an environment geographically local to a business establishment, the examined aspects including at least shopper traffic;
monitoring business resources relating to the business establishment; and
determining a traffic modifier in real time based at least in part upon the shopper traffic and the business resources.

18. The method of claim 17, further comprising at least one of the following acts:
inferring demographic information relating to the shopper traffic;
inferring objectives information relating to the shopper traffic;
obtaining a customer account ID relating to a known customer of the business establishment who is in the physical vicinity of the business establishment; or
receiving resource data relating to a distinct business establishment.

19. The method of claim 17, further comprising at least one of the following acts:
utilizing the traffic modifier to direct shopper traffic to an abundant resource;
utilizing the traffic modifier to disperse shopper traffic away from a scarce resource;
utilizing the traffic modifier to delay consumption of the scarce resource; or
determining a resource modifier by inferring a result of applying the traffic modifier.

20. A computer-implemented system for facilitating more efficient management of shopper traffic and/or resource allocation, comprising:
means for inspecting features of an environment in proximity to a business establishment, the inspected features including at least shopper traffic;
means for monitoring business resources relating to the business establishment; and
means for inferring a traffic modifier at least from the shopper traffic and the business resources.
